(19) United States
(12) Patent Application Publication
(10) Pub. No.: US 2020/0018072 A1
(43) Pub. Date: Jan. 16, 2020

(54) ROOFING SHOVEL

(71) Applicant: Danny HAMELIN-ROY, Mirabel (CA)

(72) Inventor: Danny HAMELIN-ROY, Mirabel (CA)

(21) Appl. No.: 16/512,316

(22) Filed: Jul. 15, 2019

Related U.S. Application Data
(60) Provisional application No. 62/697,666, filed on Jul. 13, 2018.

(51) Int. Cl. E04D 15/00; B25G 3/02

(52) U.S. Cl. CPC E04D 15/003; B25G 3/02

(57) ABSTRACT

A roofing shovel for prying roofing shingles from a roof comprises a head and a shaft. The head defines opposite first and second end portions, opposite lateral sides, a top surface and an undersurface and comprises prying teeth at the first and second end portions. The shaft defines a top end and a bottom end removably mounted to the head and forms a first angle with a portion of the top surface between the first end portion and the shaft and a second angle with a portion of the top surface between the second end portion and the shaft. A connection assembly is interposed between and contiguous with the shaft bottom end and the head top surface. The shaft bottom end and the head top surface comprise respective mutual connectors for connecting the shaft at, at least, a first and a second position relative to the top surface. In one of the first and second positions the first angle is greater than the second angle, and in the other of the first and second positions the second angle is greater than the first angle.

### CROSS-REFERENCE TO RELATED APPLICATIONS

The present application claims priority on U.S. Provisional Patent Application No. 62/697,666 filed on Jul. 13, 2018 and incorporated herein by reference in its entirety.

### TECHNICAL FIELD

The present disclosure generally relates to roofing. More particularly but not exclusively the present disclosure relates to roofing shovels.

### BACKGROUND

A roofing shovel is a specialized prying tool that evolved from use of spading forks and pitchforks to remove old roof shingles and underlayment as part of roof repair. Roof shingles are a roof covering consisting of individual overlapping elements. These elements are typically flat, rectangular shapes laid in courses from the bottom edge of the roof up, with each successive course overlapping the joints below. Shingles are made of various materials such as wood, slate, flagstone, metal, plastic, and composite materials such as fiber cement and asphalt shingles. Roof shingles are pried by roofing shovels. Roofing shovels include a shaft with a shovel head including prying teeth at its front end or at both the front and rear end. When the front teeth are worn out, the user needs to get a new shovel with sharper front teeth. The rear teeth cannot be used due to the angle of the shaft relative to the head. The front teeth provide for forward push prying, the rear teeth provide for rearward pull prying. Often the rear teeth are almost in perfect condition when the front teeth are completely worn out, due to the fact that the rear teeth are only occasionally used as most users rarely pry with the rear teeth if at all.

### OBJECTS

An object of the present disclosure is to provide a roofing shovel.

An object of the present disclosure is to provide a kit for a roofing shovel.

An object of the present disclosure is to provide a shoveling head for a roofing shovel.

An object of the present disclosure is to provide a shaft for a roofing shovel.

### SUMMARY

In an accordance with an aspect of the present disclosure, there is provided a roofing shovel for prying roofing shingles from a roof, the roofing shovel comprising: a head defining opposite first and second end portions, opposite lateral sides, a top surface and an undersurface, the head comprising prying teeth at the first and second end portions; a shaft defining a top end and a bottom end removably mounted to the head, the shaft forming a first angle with a portion of the top surface between the first end portion and the shaft and a second angle with a portion of the top surface between the second end portion and the shaft; a connection assembly interposed between and contiguous with the shaft bottom end and the head top surface, wherein the shaft bottom end and the head top surface comprise respective mutual connectors for connecting the shaft at, at least, a first and a second position relative to the top surface, wherein in one of the first and second positions the first angle is greater than the second angle, and in the other of the first and second positions the second angle is greater than the first angle.

In an embodiment, the shaft bottom end comprises a plaque for being mounted to the top surface of the head, the plaque and top surface defining mutual apertures for being aligned, the connectors comprising fasteners for fastening the plaque to the top surface via the aligned apertures. In an embodiment, the fasteners comprise screws and bolts.

In an embodiment, the head comprises a middle section interposed between the first and second end portions, the shaft being connected to the middle section, the middle section being upwardly positioned relative to the first and second end portions for providing a space thereunder. In an embodiment, the mutual connectors protrude into the space provided under the middle section of the head. In an embodiment, the middle section is upwardly positioned as to avoid the connectors from contacting the roof. In an embodiment, the middle section is connected to first and second end portions via first and second sloped sections therebetween. In an embodiment, the middle section defines an arch between the first end and second end portions. In an embodiment, the space provided under the middle section provides for receiving shingles therein during prying thereof. In an embodiment, the middle section defines cut-outs at each of the opposite lateral sides of the head.

In accordance with an aspect of the disclosure, there is provided a roofing shovel for prying roofing shingles from a roof, the roofing shovel comprising: a head defining opposite first and second end portions and a middle section interposed therebetween, opposite lateral sides, a top surface and an undersurface, the head comprising prying teeth at the first and second end portions, the middle section being upwardly positioned relative to the first and second end portions for providing a space thereunder; and a shaft defining a top end and a bottom end mounted to the head at the middle section thereof.

In an embodiment, the head and shaft comprise mutual connectors for being connected together, the mutual connectors protruding into the space provided under the middle section of the head. In an embodiment, the middle section is upwardly positioned as to avoid the connectors from contacting the roof.

In an embodiment, the middle section is connected to first and second end portions via first and second sloped sections therebetween.

In an embodiment, the middle section defines an arch between the first end and second end portions.

In an embodiment, the space provided under the middle section provides for receiving shingles therein during prying thereof.

In an embodiment, the middle section defines cut-outs at each of the opposite lateral sides of the head.

In accordance with an aspect of the disclosure, there is provided a kit for a roofing shovel for roofing shovel for prying roofing shingles from a roof, the kit comprising: a shovel head defining opposite first and second end portions, opposite lateral sides, a top surface and an undersurface, the head comprising prying teeth at the first and second end portions; and a plaque for being removably mounted to the shovel head and comprising a socket for removably receiving a shaft therein, the socket upwardly extending from the plaque and defining a first angle between a first part of the plaque and the socket and a second angle between a second part of the plaque and the socket, the plaque been mountable to the shovel head top surface at least at a first position and a second position, wherein in the first position, the first angle is positioned in the direction of the first end portion of the head and the second angle is positioned in the direction of the second end portion of the head, wherein in the second position, the first angle is positioned in the direction of the second end portion of the head and the second angle is positioned in the direction of the first end portion of the head.

In an embodiment, the head comprises a middle section interposed between the first and second end portions, the plaque being connected to the middle section, the middle section being upwardly positioned relative to the first and second end portions for providing a space thereunder.

In an embodiment, the middle section defines an arch between the first end and second end portions.

Other objects, advantages and features of the present disclosure will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 perspective, top and front view of the roofing shovel in accordance with a non-restrictive illustrative embodiment of the present disclosure;

FIG. 2 is a perspective view of a roof including roofing shingles;

FIG. 3 is a close-up view of the roofing shovel of FIG. 1;

FIG. 4 is a top and side perspective view of the roofing shovel of FIG. 1;

FIG. 5 is a side view of the roofing shovel of FIG. 1;

FIG. 6 is a bottom view of the roofing shovel of FIG. 1;

FIG. 7 is a perspective view of the roofing shovel of FIG. 1 in a disassembled position; and

FIG. 8 is a top view of a shoveling head of a roofing shovel in accordance with another non-restrictive illustrative embodiment of the present disclosure.

### DETAILED DESCRIPTION OF ILLUSTRATIVE EMBODIMENTS

Generally stated and in accordance with a there is provided a roofing shovel for prying roofing shingles from a roof. The roofing shovel comprises a head and a shaft. The head defining opposite first and second end portions, opposite lateral sides, a top surface and an undersurface. The head comprises prying teeth at the first and second end portions. The shaft defines a top end and a bottom end removably mounted to the head. The shaft forms a first angle with a portion of the top surface between the first end portion and the shaft and a second angle with a portion of the top surface between the second end portion and the shaft. A connection assembly is interposed between and contiguous with the shaft bottom end and the head top surface. The shaft bottom end and the head top surface comprise respective mutual connectors for connecting the shaft at, at least, a first and a second position relative to the top surface. In one of the first and second positions the first angle is greater than the second angle, and in the other of the first and second positions the second angle is greater than the first angle.

Generally stated and in accordance with a there is provided a roofing shovel for prying roofing shingles from a roof. The roofing shovel comprises a head and a shaft. The head defines opposite first and second end portions and a middle section interposed therebetween, opposite lateral sides, a top surface and an undersurface. The head comprises prying teeth at the first and second end portions. The middle section is upwardly positioned relative to the first and second end portions for providing a space thereunder. The shaft defines a top end and a bottom end mounted to the head at the middle section thereof.

Generally stated and in accordance with a there is provided a kit for a roofing shovel for roofing shovel for prying roofing shingles from a roof. The kit comprises a shovel head and plaque for being removably mounted to the shovel head. The shovel head defines opposite first and second end portions, opposite lateral sides, a top surface and an undersurface. The head comprises prying teeth at the first and second end portions. The plaque comprises a socket for removably receiving a shaft therein. The socket upwardly extends from the plaque and defines a first angle between a first part of the plaque and the socket and a second angle between a second part of the plaque and the socket. The plaque is mountable to the shovel head top surface at, at least a first position and a second position. In the first position, the first angle is positioned in the direction of the first end portion of the head and the second angle is positioned in the direction of the second end portion of the head. In the second position the first angle is positioned in the direction of the second end portion of the head and the second angle is positioned in the direction of the first end portion of the head.

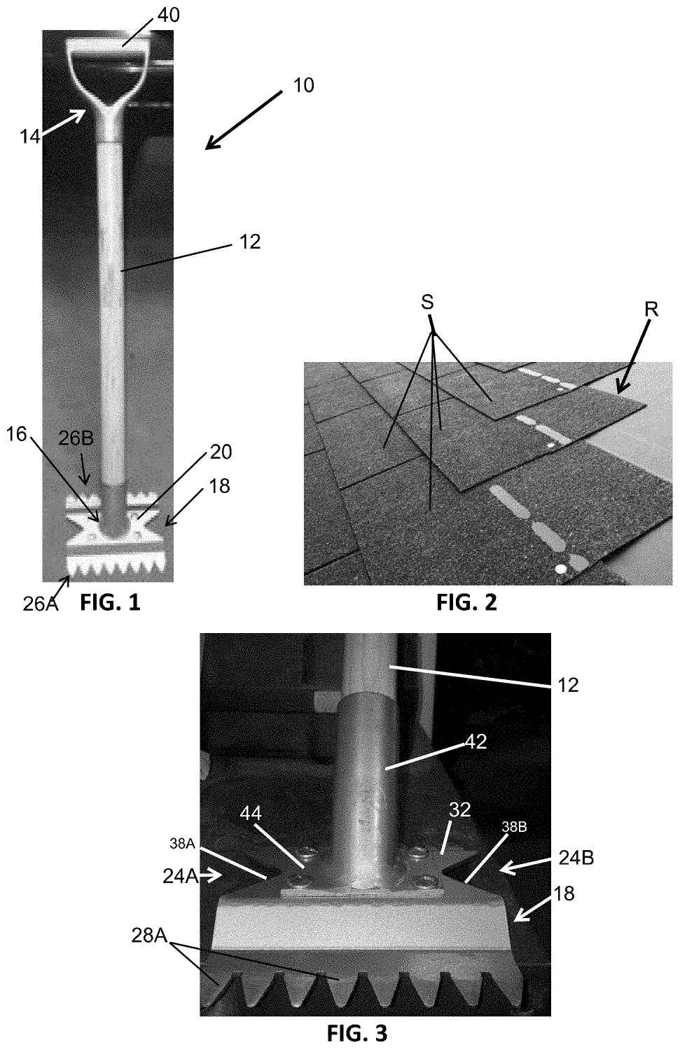

With reference to FIGS. 1 and 2 to 7 show a roofing shovel 10 including an elongate shaft 12 having a top end 14 and a bottom end 16 connected to a shoveling head 18.

The shoveling head 18 defines a top surface 20 and an opposite undersurface 22, lateral sides 24A and 24B as well opposite first and second end parts 26A and 26B respectively, including respective prying teeth 28A and 28B.

As will be explained herein, either one of prying teeth 28A and 28B can be used for forward push prying of roofing shingles S from a roof R (see FIG. 2).

It is to be noted that the terms “first” and “second” are used herein only for indicative purpose and are thus interchangeable.

The head 18 defines first and second flat sections 30A and 30B that are in contact with the roof R (and shingles R) and a middle upwardly lifted or arched section 32, interposed therebetween, that is not in contact with the roof R. The first and second flat sections 30A and 30B respectively comprise the prying teeth 28A and 28B. The undersurface 22 thus comprises three surface sections namely first and second sections 22A and 22B which engage the roof R and a middle surface section 22C which forms the undersurface portion of the middle upwardly lifted section 32.

The middle upwardly lifted section 32 comprises a central flat body 34 that is upwardly positioned relative to the flat sections 30A and 30B and connected thereto via sloped portions 36A and 36B of the middle upwardly section 32. Accordingly, the middle section 22C comprises the sloped portion undersurfaces 22Ci, 22Cii and the central body undersurface 22Ciii.

The flat central body 34 has lateral cut-out portions 38A and 38B which form part of the lateral sides 24A and 24B respectively. The cut-out portions 38A and 38B have a generally triangular configuration.

With particular reference to FIG. 5, the shaft 12 is mounted to the head 18 forming a first angle ‘α’ relative to the top surface portion 20 (between the first end portion 26A and the shaft 12) and forming a second angle ‘β’ relative to the top surface portion 20 of the central body (between the second end portion 26B and the and shaft 12). The sum of angles α and β being 180° with angle ‘α’ being greater than 90° and angle ‘β’ being less than 90°. As such, in the foregoing configuration, the first end portion 26A is the front side and the second end portion 26B is the rear side as the position of the shaft 12 relative to the top surface 20 of the central body 34 provides for the user to push the shovel 10 forward with the leading edge being defined by the prying teeth 28A. As shown in FIG. 8, the shaft 12 is removable and can be repositioned (by turning it 180° about its axis as shown by arrow C) on the shoveling head 18 with angle ‘α’ being less than 90° and angle ‘β’ being more than 90°. As such, in this foregoing configuration, the first end portion 26A is the rear side and the second end portion 26B is the front side as the position of the shaft 12 relative to the top surface 20 provides for the user to push the shovel forward with the leading edge being defined by the prying teeth 28B.

The shaft 12 includes at its top end 14 a handle grip 40 and a socket 42 at its bottom end 16 which terminates with a plaque 44 removably fastened to the central body 34. Angles α and β are defined between a first part 44′ of the plaque 44 and the socket 42 and a second part 44″ of the plaque 44 and the socket 42.

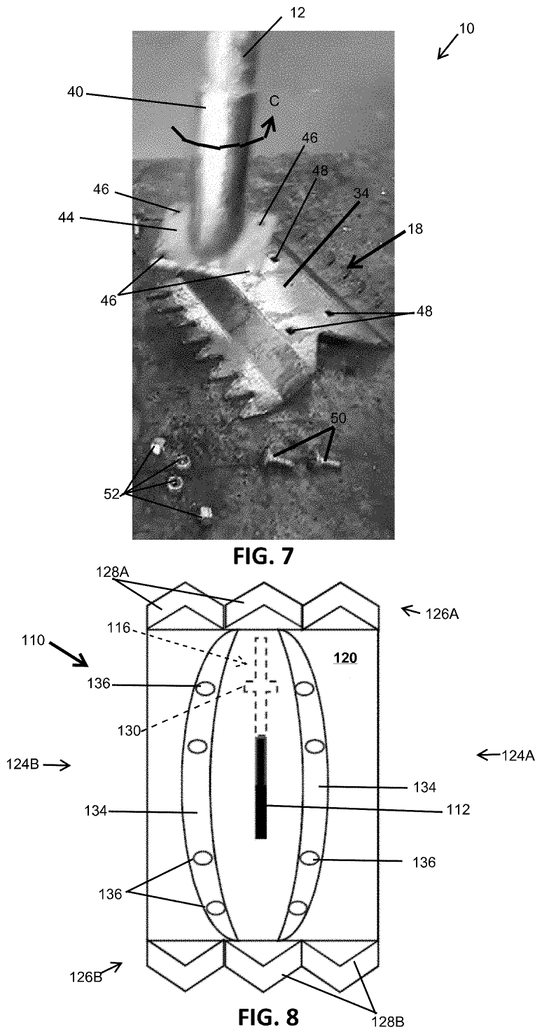

With respect to FIGS. 6 and 7, the plaque 44 defines apertures 46 which are aligned with like apertures 48 in the central body 34. Fasteners 50, such as screws are placed in the aligned apertures 46 and 48 via the top surface 20. The fasteners 50 protrude from the undersurface 22 and are locked in place via bolts 52 at undersurface portion 22Ciii.

In order to turn the shaft 12 (as shown by arrow C), the user removes the bolts 52 to release the screws 50 in order to release the shaft 12 from the head 18 and then turns the shaft 12 or the head 18 for repositioning as explained above. The apertures 46 and 48 are aligned, the screws 50 are put back in place and then bolted via bolts 52. As such, the user can selectively and easily switch the leading edge from prying teeth 26A to prying teeth prying teeth 26B and vice versa.

In the art, both the front and rear sides have prying teeth and the shaft is inclined towards the user who pries the shingles off the roof R. As such, the leading edge teeth get worn out faster than the rear end teeth. Moreover, the rear end teeth do not need to be as sharp as the leading edge teeth and in fact, can be blunt. Therefore, with the present roofing shovel 10, the user does not need to discard the shovel once the leading edge teeth are blunted. The user can change the direction of the shoveling head 18 as explained above and the previously rear end teeth 26B for example, become the leading edge teeth and the previously leading edge teeth 26A become the rear end teeth.

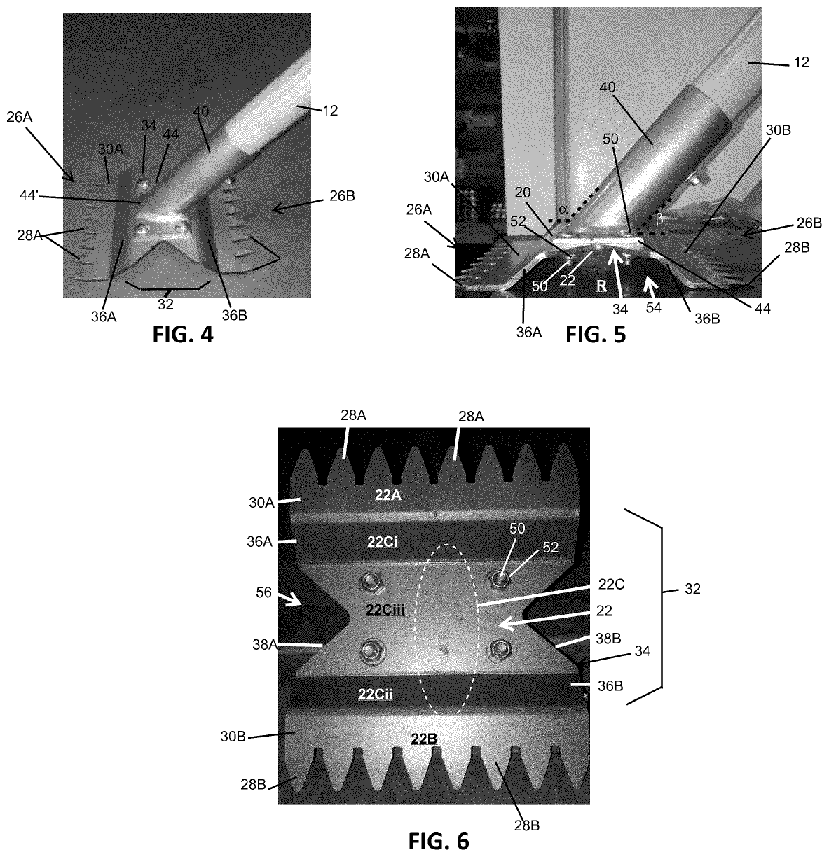

The middle upwardly lifted section 32 defines a space 54 (see FIG. 4) with the roof R surface. This space 54 provides a clearance for the fasteners 50 and 52 at the undersurface 22Ciii. Thus, the fasteners 50 and 52 do not engage the roof R as the undersurface 22C of the middle upwardly lifted section 32 is arched above the roof R. The configuration of this arch, allows a space 54 for the shingles S to upwardly move into as they are pried off the roof R. The fact that only the undersurface sections 22A and 22B are in contact with the roof R and shingles S, there is less damage likely to the undersurface 22 of the head 18. The arch like configuration of space 54 is provided by the sloped undersurface portions 22Ci and 22Cii and the flat longer undersurface 22Ciii. The sloped undersurfaces 22Ci or 22Cii (directly behind the leading edge 26A or 26B) provides an upward slide to shingle S as it is pried off. The foregoing structure facilitates shingle removal when compared to flat undersurface roofing shovel heads.

The arch 54 allows the angle of the shaft 12 vis-a-vis the head 18 on the user's side to be greater than standard angles. In an embodiment, this angle is between 40° and 45°. In an embodiment, this angle is 43°. Therefore providing the arch space 54 for the shingles S to slide into provides for the shaft 12 to be less inclined towards the user thus allowing the user to bend over to a lesser degree due to the greater angle (e.g. 43°, 44°, 45°) discussed above thereby making the roofing shovel 10 safer for users and easier to use.

The cut-out portions 38A and 38B also provide a space 56 for the shingles S to lift into when being pried. Moreover, the cut-out portions 38A and 38B reduce the weight of the head 18 and compensate for the overlying pieces of the plaque 44 and central body 34.

The plaque 44, the central body 34, the apertures, 46 and 48 and the fasteners 50 and 52 form a connection assembly interposed between the shaft 12 and the head 18 and contiguous therewith. The apertures 46 and 48 and the fasteners 50 and 52 define mutual connectors of the shaft 12 and head 18.

Turning to FIG. 8, the is shown a roofing shovel 110 including a shaft 112 and a head 118 having a flat generally rectangular body with straight lateral sides 124A and 124B. The head 118 defines a top surface 120 and an opposite undersurface thereof (now shown) which fully engaging the roof surface R. The shaft 112 has a bottom end 116 with connectors 130. In this form the connectors 30 are reciprocally inward and outward spring-loaded side protrusions controlled by a finger switch 132 on the shaft 112 for being pulled inwards into the body of the bottom end 116 and released to their outwardly biased position.

The top surface 120 of the head 118 includes side brackets 134 for receiving the bottom end 116 therebetween. The side brackets 134 include connectors 136 for mutual removable connection with the connectors 130 of the shaft 112. In this example, the connectors of the 136 of the head 118 are aligned pairs of holes for receiving respective protrusions 130 therein for a releasable lock fit. The shaft 112 is removed by pulling the protrusions 130 out of the holes 136 and therefore inward into the body of the bottom end 116. In this way, the shaft 112 can be positioned with varying angle ‘α’ and angle ‘β’ configuration providing for either the first or second longitudinal end parts 126A or 126B to be the front side for forward push prying of roof shingles S. As such, when one of the prying teeth 128A or 1286 are worn out, the user can switch sides and use the other set of prying teeth 128A or 128B.

The connectors 130 and 136 form a connection assembly.

The various features described herein can be combined in a variety of ways within the context of the present disclosure so as to provide still other embodiments. As such, the embodiments are not mutually exclusive. Moreover, the embodiments discussed herein need not include all of the features and elements illustrated and/or described and thus partial combinations of features can also be contemplated. Furthermore, embodiments with less features than those described can also be contemplated. It is to be understood that the present disclosure is not limited in its application to the details of construction and parts illustrated in the accompanying drawings and described hereinabove. The disclosure is capable of other embodiments and of being practiced in various ways. It is also to be understood that the phraseology or terminology used herein is for the purpose of description and not limitation. Hence, although the present disclosure has been provided hereinabove by way of non-restrictive illustrative embodiments thereof, it can be modified, without departing from the scope, spirit and nature thereof and of the appended claims.

What is claimed is:

1. A roofing shovel for prying roofing shingles from a roof, the roofing shovel comprising:
a head defining opposite first and second end portions, opposite lateral sides, a top surface and an undersurface, the head comprising prying teeth at the first and second end portions;
a shaft defining a top end and a bottom end removably mounted to the head, the shaft forming a first angle with a portion of the top surface between the first end portion and the shaft and a second angle with a portion of the top surface between the second end portion and the shaft;
a connection assembly interposed between and contiguous with the shaft bottom end and the head top surface, wherein the shaft bottom end and the head top surface comprise respective mutual connectors for connecting the shaft at, at least, a first and a second position relative to the top surface,
wherein in one of the first and second positions the first angle is greater than the second angle, and in the other of the first and second positions the second angle is greater than the first angle.

2. A roofing shovel according to claim 1, wherein the shaft bottom end comprises a plaque for being mounted to the top surface of the head, the plaque and top surface defining mutual apertures for being aligned, the connectors comprising fasteners for fastening the plaque to the top surface via the aligned apertures.

3. A roofing shovel according to claim 2, wherein the fasteners comprise screws and bolts.

4. A roofing shovel according to claim 1, wherein the head comprises a middle section interposed between the first and second end portions, the shaft being connected to the middle section, the middle section being upwardly positioned relative to the first and second end portions for providing a space thereunder.

5. A roofing shovel according to claim 4, wherein the mutual connectors protrude into the space provided under the middle section of the head.

6. A roofing shovel according to claim 5, wherein the middle section is upwardly positioned as to avoid the connectors from contacting the roof.

7. A roofing shovel according to claim 4, wherein the middle section is connected to first and second end portions via first and second sloped sections therebetween.

8. A roofing shovel according to claim 4 wherein the middle section defines an arch between the first end and second end portions.

9. A roofing shovel according to claim 4, wherein the space provided under the middle section provides for receiving shingles therein during prying thereof.

10. A roofing shovel according to claim 4, wherein the middle section defines cut-outs at each of the opposite lateral sides of the head.

11. A roofing shovel for prying roofing shingles from a roof, the roofing shovel comprising:
a head defining opposite first and second end portions and a middle section interposed therebetween, opposite lateral sides, a top surface and an undersurface, the head comprising prying teeth at the first and second end portions, the middle section being upwardly positioned relative to the first and second end portions for providing a space thereunder; and
a shaft defining a top end and a bottom end mounted to the head at the middle section thereof.

12. A roofing shovel according to claim 11, wherein head and shaft comprise mutual connectors for being connected together, the mutual connectors protruding into the space provided under the middle section of the head.

13. A roofing shovel according to claim 12, wherein the middle section is upwardly positioned as to avoid the connectors from contacting the roof.

14. A roofing shovel according to claim 11, wherein the middle section is connected to first and second end portions via first and second sloped sections therebetween.

15. A roofing shovel according to claim 11 wherein the middle section defines an arch between the first end and second end portions.

16. A roofing shovel according to claim 11, wherein the space provided under the middle section provides for receiving shingles therein during prying thereof.

17. A roofing shovel according to claim 11, wherein the middle section defines cut-outs at each of the opposite lateral sides of the head.

18. A kit for a roofing shovel for roofing shovel for prying roofing shingles from a roof, the kit comprising:
a shovel head defining opposite first and second end portions,
opposite lateral sides, a top surface and an undersurface, the head comprising prying teeth at the first and second end portions; and
a plaque for being removably mounted to the shovel head and comprising a socket for removably receiving a shaft therein, the socket upwardly extending from the plaque and defining a first angle between a first part of the plaque and the socket and a second angle between a second part of the plaque and the socket, the plaque been mountable to the shovel head top surface at least at a first position and a second position,
wherein in the first position, the first angle is positioned in the direction of the first end portion of the head and the second angle is positioned in the direction of the second end portion of the head,
wherein in the second position, the first angle is positioned in the direction of the second end portion of the head and the second angle is positioned in the direction of the first end portion of the head.

19. A roofing shovel according to claim 18, wherein the head comprises a middle section interposed between the first and second end portions, the plaque being connected to the middle section, the middle section being upwardly positioned relative to the first and second end portions for providing a space thereunder.

20. A roofing shovel according to claim 19, wherein the middle section defines an arch between the first end and second end portions.
